(19) United States
(12) Patent Application Publication
(10) Pub. No.: US 2017/0169396 A1
(43) Pub. Date: Jun. 15, 2017

(54) TRANSPORT AND TRANSPORTATION SYSTEMS AND METHOD FOR SAME

(71) Applicant: CyberTAN Technology, Inc., Hsinchu (TW)

(72) Inventors: GUAN-RONG LIN, Hsinchu (TW); SHUN-MIN HSU, Hsinchu (TW); YU-YANG LIN, Hsinchu (TW)

(21) Appl. No.: 15/213,339

(22) Filed: Jul. 18, 2016

(30) Foreign Application Priority Data
Dec. 11, 2015 (TW) 104141691

(51) Int. Cl. G06Q 10/10; H04L 29/06

(52) U.S. Cl. CPC G06Q 10/1093; H04L 65/4076

(57) ABSTRACT

A transportation system between dispatchers and individual recipients includes a first transport-requirement device, a second transport-requirement device, a transport-execution device, and a data processing server. The first transport-requirement device and the second transport-requirement device respectively provides first plan information and second plan information, such information comprising start-locations of a first and a second plan, a destination-locations of the first and the second plan, and start-times of the first and the second plan. The transport-execution device provides driver information and driver confirmation of readiness. The data processing server provides carpool plans to the transport-execution device according to the driver locations. The data processing server obtains end-time of the first and the second plan according to the first and the second plan information, and generates carpool plans according to the relationship between first and the second plan information.

### FIELD

The disclosure relates to transport and transportation systems.

### BACKGROUND

There are different types of transport methods, such as express delivery, surface and air mailing, and home delivery, etc. Shopping on the internet, the demand for individual deliveries increases day by day. More demand for deliveries will require more delivery people to transport goods. For improving delivery efficiency, it is required to establish a transport system with higher integration.

Transport methods are based on rules set by logistics industry, training for the professional people, or equipment of transport tools, to make sure of accurate and timely deliveries. However, many conventional transport systems do not provide a service to match recipients with delivery requirements.

### BRIEF DESCRIPTION OF THE DRAWINGS

Implementations of the present technology will now be described, by way of example only, with reference to the attached figures, wherein:

FIG. 1 is a block diagram of a transport system according to an embodiment of the disclosure;

FIG. 2 is a block diagram of a transport system according to an embodiment of the disclosure;

FIG. 3 is a flow chart of the delivery service demand in the transport system according to an embodiment of the disclosure;

FIG. 4 is a flow chart of the provision of a delivery service in the transport system according to an embodiment of the disclosure;

FIG. 5 is a flow chart of information process in the transport system according to an embodiment of the disclosure;

FIG. 6 is a schematic view showing two transport plans being combined according to their positional relationship;

FIG. 7A and FIG. 7B are schematic views of a relay type according to an embodiment of the disclosure;

FIG. 8A and FIG. 8B are schematic views of a carry type according to an embodiment of the disclosure; and

FIG. 9A and FIG. 9B are schematic views of a cover type according to an embodiment of the disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. The term “comprising,” when utilized, means “including, but not necessarily limited to”; it specifically indicates open-ended inclusion or membership in the so-described combination, group, series, and the like. References to “an” or “one” embodiment in this disclosure are not necessarily to the same embodiment, and such references mean “at least one.”

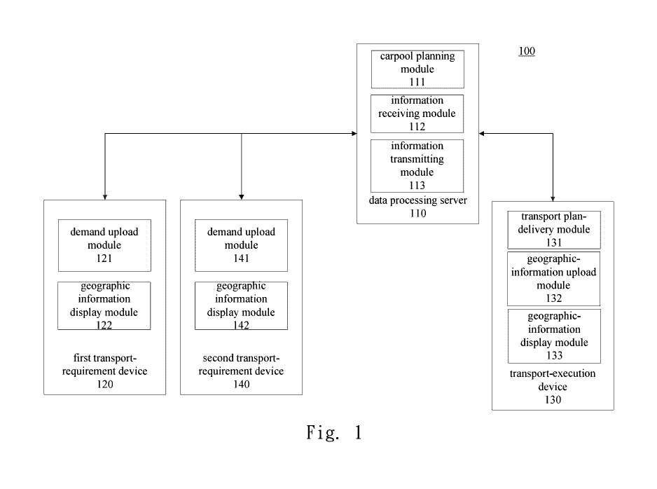

FIG. 1 shows a transport system according to an embodiment of the disclosure. The transport system comprises a data processing server 110, a first transport-requirement device 120, a transport-execution device 130 and a second transport-requirement device 140.

The first transport-requirement device 120 comprises a demand upload module 121 and a geographic-information display module 122. The first transport-requirement device 120 provides first plan information which is set on the first transport-requirement device 120 by customer demands to the data processing server 110 through the demand upload module 121. The second transport-requirement device 140 comprises a demand upload module 141 and a geographic-information display module 142. The second transport-requirement device 140 provides second plan information which is set on the second transport-requirement device 140 by customer demands to the data processing server 110 through the demand upload module 141.

The data processing server 110 comprises a carpool planning module 111, an information receiving module 112, and an information transmitting module 113. The information receiving module 112 receives the first plan information from the first transport-requirement device 120, the second plan information from the second transport-requirement device 140, and information as to the respective locations and readiness of drivers from the transport-execution device 130. The carpool planning module 111 generates a carpool plan according to the collected information, where the term “carpool plan” in this embodiment means the combining of different carpool plans into one plan, for deliveries from a nearby pick-up point, or which are to be made to a nearby delivery point, or are on a nearby route, within a period of time.

The data processing server 110 generates the carpool plans according to the first plan information and the second plan information, and provides the carpool plans to the transport-execution devices 130 and 160, according to the respective information of drivers. The data processing server 110 obtains the end-time of the first plan according to the first plan information, obtains the end-time of the second plan according to the second plan information, and generates a combined carpool plan according to a relationship among the first plan information, the end-time of the first plan, the second plan information and the end-time of the second plan. The data processing server 110 bases the plurality of carpool plans according to the locational information received from the transport-execution devices 130 and 160. The information transmitting module 113 transmits the combined carpool plan to the transport-execution device 130 for drivers to accept the plan. The data processing server 110 provides a status tracking service for the first transport-requirement device 120 and the second transport-requirement device 140 according to driver's information. The driver's information includes the information of the transport-execution device 130 accepts or ignores the broadcast messages, the information of the transport-execution device 130 accepts or rejects the plan be assigned by the data information server 110, the location information of the transport-execution device 130, and the shipping restriction (service time, weight restriction, size restriction), the description information is not to be considered as limiting the scope of the embodiments described herein.

The transport-execution device 130 comprises a transport plan-delivery module 131, a geographic-information upload module 132, and a geographic-information di splay module 133. When assigning the plans, the transport plan-delivery module 131 provides a plan accept and confirm service, receives the first to the N-th plan information from the data processing server 110 and forwards confirmatory messages to the data processing server 110. The geographic-information upload module 132 provides driver locations information to generate the plan to the carpool planning module 111 of the data processing server 110. After receiving the plans, the geographic-information upload module 132 on the transport-execution devices 130 provides continuous tracking of the driver location to the data processing server 110 for providing the status tracking service. The geographic-information display module 133 displays the start location, the destination location, and the route taken. A route planning method will be described hereafter.

FIG. 1 shows two transport-requirement devices and one transport-execution device. However, the number of transport-requirement devices and transport-execution devices is only an example in the embodiment and is not to be limiting. In practice, a plurality of transport-requirement devices and transport-execution devices may be operated.

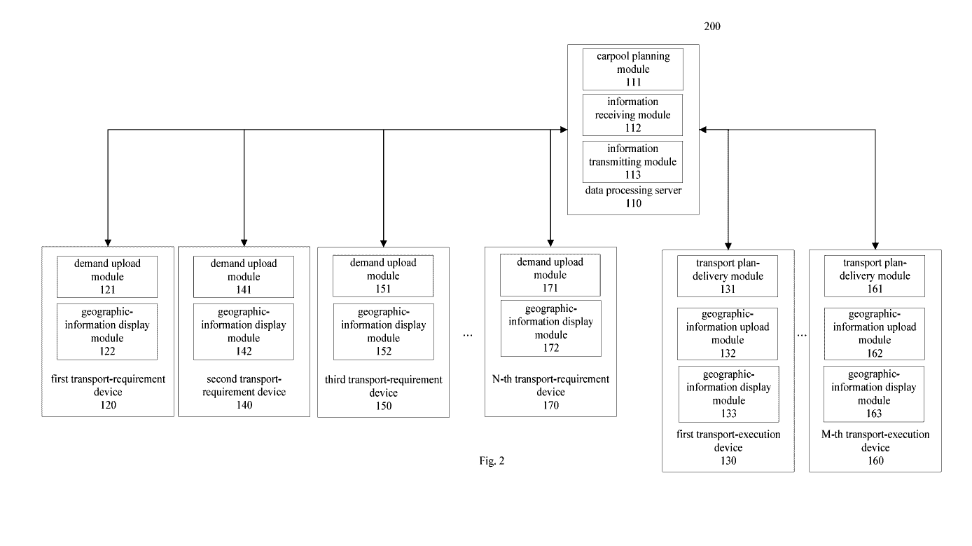

FIG. 2 shows a transport system according to an embodiment of the disclosure. This embodiment of the transport system comprises a third transport-requirement device 150, which provides third plan information, the third plan information comprises a start-location of the third plan, a destination-location of the third plan and a start-time of the third plan. An embodiment of the transport system comprises N transport-requirement devices and M transport-execution devices, where N and M can be any positive integers. The N-th transport-requirement device 170 provides N-th plan information. The M-th transport-execution device 160 comprises the transport plan-delivery module 161, the geographic-information upload module 162, and the geographic-information display module 163.

The data processing server 110 plans the transport route according to the first plan information and the second plan information. The first plan information comprises a start-location of a first plan, a destination-location of the first plan, a start-time of the first plan T_{S1} and carpool information of the first plan. The second plan information comprises a start-location of a second plan, a destination-location of the second plan, a start-time of the second plan T_{S2} and carpool information of the second plan. The end-time of the first plan T_{E1} and the end-time of the second plan T_{E2} can be calculated using Google Direction API (GDA) or any other routing time calculation methods according to the first plan information and the second plan information. The data processing server 110 may generate plans according to the relationship among the start-location of the first plan, the destination-location of the first plan, the start-time of the first plan T_{S1}, the end-time of the first plan T_{E1}, the start-location of the second plan, the destination-location of the second plan, the start-time of the second plan T_{S2}, and the end-time of the second plan T_{E2}. The data processing server 110 may generate the plans by comparing all information of plans received. For example, the data processing server 110 may compare the N-th plan information with the first plan information to the (N−1)-th plan information when there are N plans information received. The N-th plan information comprises an N-th plan start-location, an N-th plan destination-location, and an N-th plan start-time T_{SN}. An N-th plan end-time T_{EN} may be calculated by GDA or any other routing time calculation methods according to the N-th information. The data processing server 110 may generate plans according to the relationship among the N-th plan start-location, the N-th plan destination-location, the N-th plan start-time T_{SN}, the N-th plan end-time T_{EN}, the first to (N−1)-th plan start-location, the first to (N−1)-th plan destination-location, the first to (N−1)-th plan start-time T_{S1} to T_{S(N-1)}, and the first to (N−1)-th plan end-time T_{E1} to T_{E(N-1)}. For example, the data processing server 110 can generate the carpool plans according to third plan information, wherein the data processing server obtains the end-time of the third plan according to the third plan information, and generates the carpool plans according to the relationship between the third plan information, the end-time of the third plan, the first plan information, the end-time of the first plan, the second plan information, and the end-time of the second plan. After generating the plans, when the carpool information of the first plan and the carpool information of the second plan participate the carpool plans, the data processing server 110 broadcasts the request for looking the drivers who accepts the carpool plan. When the carpool information of the first plan or the carpool information of the second plan does not participate in the carpool plan, the data processing server 110 looking for the driver who accepts a single plan. The data processing server 110 can also assigns the carpool plans to the transport-execution device according to the driver's information which received from the transport-execution device.

The driver's information can be displayed by the geographic-information display modules 122, 142, and 152 of the transport-requirement devices 120, 140, and 150. The driver's information and the plan's location may be displayed by the geographic-information display modules 133 and 163 of the transport-execution devices 130 and 160.

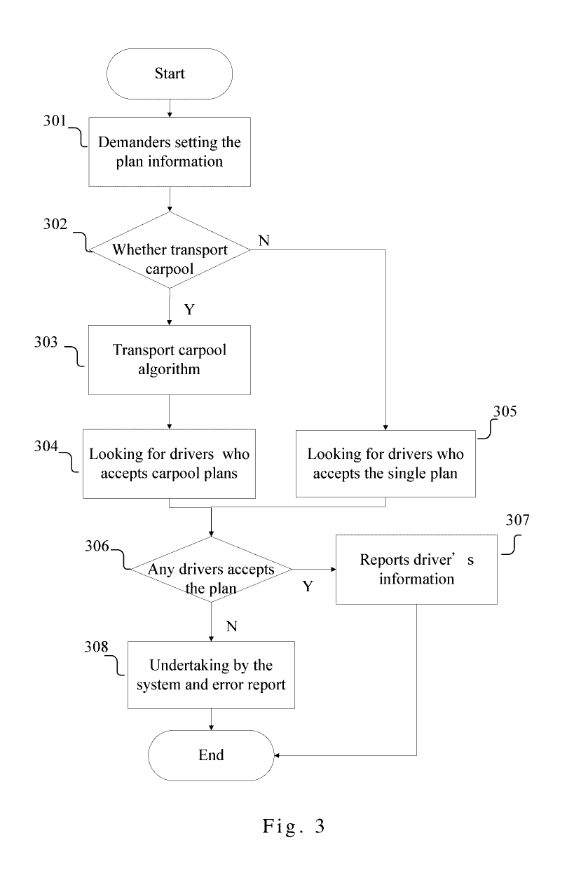

FIG. 3 is a flow chart of delivery demand in the transport system according to an embodiment of the disclosure. As shown, the demand process according to an embodiment of the disclosure includes following steps. First, in step 301, when there is a distribution of demand, users can set the plan information through the user interface of the transport-requirement devices 120, 140, and 150. The plan information may comprise a plan start-location, a plan destination-location, and a plan start-time. In step 302, the customer or enterprise which requires a delivery (demander) can make a choice on the user interface to participate or not participate with other demanders in the carpool plan. When the demander rejects the carpool plan, the process goes to step 305. In step 305, the data processing server 110 broadcasts a request for a driver would like to accept the single plan. In step 306, the process checks whether any driver accepts such a plan. When there is no driver accepting the plan, the process goes to step 308 to report the situation to the data processing server 110 or allocate the plan to specific drivers by system. When there is a driver accepting the plan, the process goes to step 307 to report the information of the driver who accepted the plan to the data processing server 110. In step 302, when more than one demander has accepted the carpool plan, the accepted plans will be put in a plan pool and await pairing with other's plans. In step 303, the plans in the plan pool pairing with others according to the transport algorithm. The data processing server 110 compares all plans in the plan pool and makes pairs which have similar conditions. After making a pair, the process goes to step 304. In step 304, the data processing server 110 searches for the drivers according to the geographic-information. In step 306, the process checks whether drivers are found. In step 308, when no driver is found, the transport-requirement devices 120, 140, and 150 report the situation to the data processing server 110. The data processing server 110 allocates the plans to specific drivers. In step 307, when there is a driver accepting the plan, the transport-requirement devices 120, 140, and 150 report the information of the driver who accepts the plan to the data processing server 110.

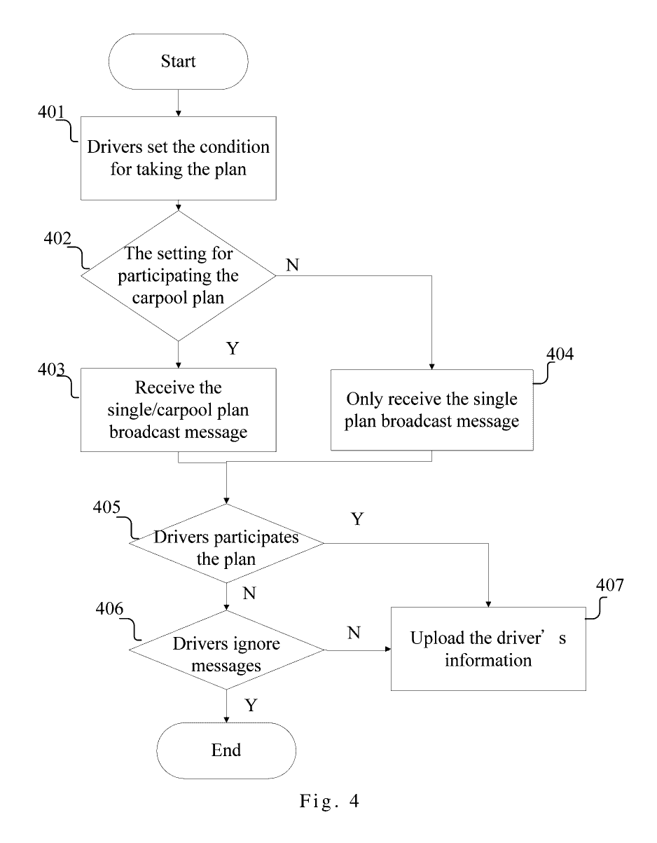

FIG. 4 is a flow chart of the provision of a delivery service in the transport system according to an embodiment of the disclosure. As shown, the driver's process in the transportation planning system according to an embodiment of the disclosure includes following steps. First, after accepting the plan, the drivers can set the condition (step 401) through the user interface on the transport-execution device 130. The processing server 110 checks whether the driver participates the carpool plans or not (step 402). When the driver does not participate the carpool plans, the transport-execution devices 130 and 160 ignore the carpool plan messages which are broadcasted from the data processing server 110 (step 404). When the driver participates the carpool plans, the transport-execution devices 130 and 160 receive the single plan messages and carpool plan messages are broadcasted from the data processing server 110 (step 403). After the transport-execution devices 130 and 160 received the messages, the driver may make the decision on the user interface to participate or not participate the plan (step 405). When the driver ignore the messages the process is finished (step 406). When the driver reject participate the plan, the transport-execution device 130 and 160 upload the driver's information to the data processing server 110. When the driver participate the plan, the transport-execution devices 130 and 160 report the processing progress and upload the driver's information to the data processing server 110 (step 407).

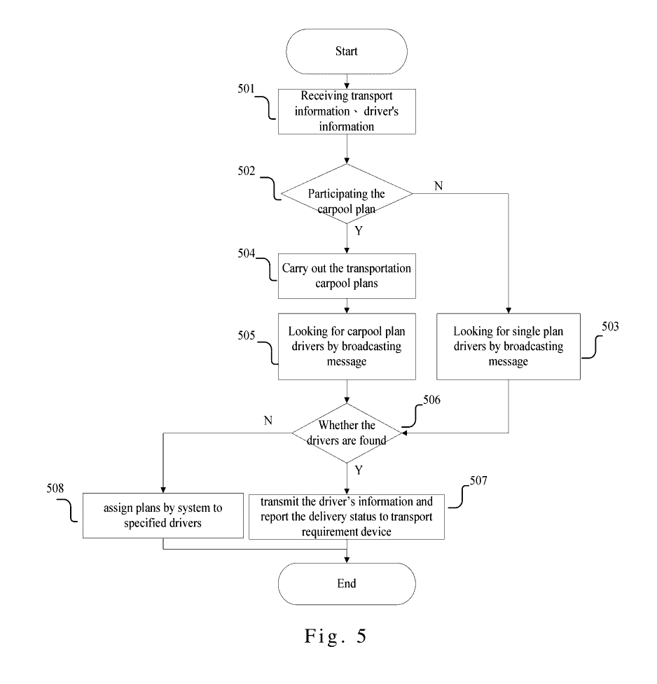

FIG. 5 is a flow chart of information process in the transport system according to an embodiment of the disclosure. As shown, the plan in the transportation planning system according to an embodiment of the disclosure includes following steps. First, the data processing server 110 receives the locations of drivers and the transportation information provided by customer demands (step 501). In an embodiment, the transportation information includes the plan start-location, the plan destination-location, and the plan start-time, and the driver locations information includes driver's geographic-information. The process checks whether the transport-requirement devices 120, 140, 150, and 170 participate a transportation carpool plan or not participate the transportation carpool plan according to transport information set by the customer demands (step 502). When the demander does not participate the transportation carpool plan, the data processing server 110 broadcasts the notifications to specific area according to the driver's geographic-information or assigns the carpool plans to the specified drivers according to the driver's information for looking the driver would like to accept the single plan (step 503). When the demander participates the transportation carpool plan, the carpool planning module 111 carries out the transportation carpool plans (step 504). The data processing server 110 broadcasts the notification to specific area according to the information as to the respective locations and readiness of drivers who participates the carpool plans or assigns the carpool plans to the specified drivers according to the driver's information (step 505). The data processing server 110 checks whether the driver participate or not participate the carpool plan according to the driver confirmation or timeout message from the transport-execution device (step 506). When the data processing server 110 receives the driver confirmation from the transport-execution devices 130 and 160. The data processing server 110 transmits the driver's information and reports the delivery status to the transport-requirement devices 120, 140, 150, and 170 (step 507). When the data processing server 110 doesn't receive the driver confirmation from the transport-execution devices 130 and 160, the data processing server 110 assigns the plan to the specific drivers or reports the delivery status to the transport-requirement devices 120, 140, 150, and 170 (step 508).

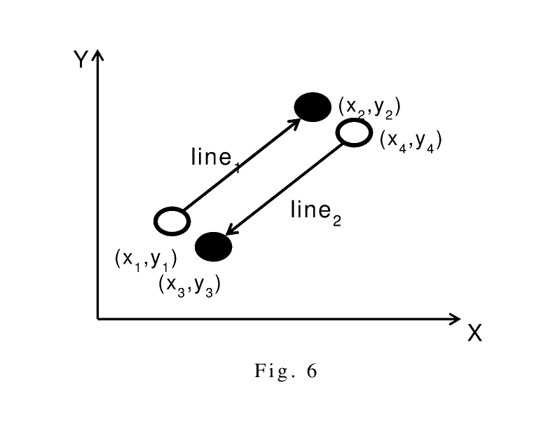

FIG. 6 is a schematic view showing two transport plans are combined according to their positional relationship. As shown, line₁ indicates the path of the first plan, line₂ indicates the path of the second plan. FIG. 6 further shows a start coordinate of the first plan (x1, y1), a destination coordinate of the first plan (x2, y2), a start coordinate of the second plan (x4, y4), and a destination coordinate of the second plan (x3, y3). In general, the transportation path plans usually integrate different transportation plans according to a nearby pick-up point or a nearby delivery point, but it is not consider about time factor between the plans. The transportation planning system according to an embodiment of the disclosure generates the transportation schedule according to the information of time and space parameters.

The carpool plan conditions discussed in the embodiments according to the disclosure can be classified as relay type, carry type and cover types.

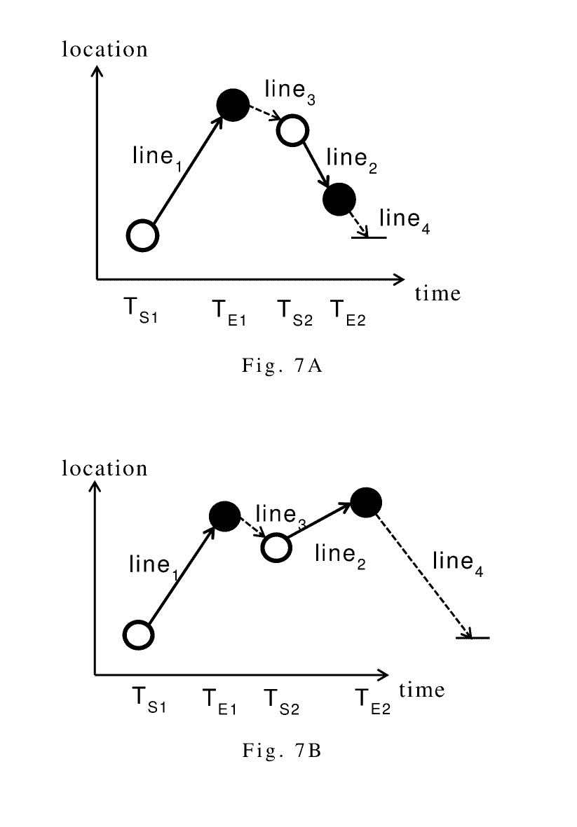

FIG. 7A and FIG. 7B show the relay type according to an embodiment of the disclosure. As shown, in relay type, the start-time of the second plan happens later than the end-time of the first plan (T_{S2}>T_{E1}), a time interval between the end-time of the first plan and the start-time of the second plan is less than a first threshold (ε₁), wherein the default value of the first threshold ε₁ can be 5 minutes. The relay type can be further divided into a backward type and a forward type. FIG. 7A shows an example of the backward type, wherein a first time period (Tₗᵢₙₑ₁) is the time taken from the start-location of the first plan to the destination-location of the first plan, a second time period (Tₗᵢₙₑ₄) is the time taken from the destination-location of the second plan return to the start-location of the first plan, the second time period less than the first time period (Tₗᵢₙₑ₄<Tₗᵢₙₑ₁). FIG. 7B shows an example of the forward type, wherein the second time period exceeds the first time period (Tₗᵢₙₑ₄>Tₗᵢₙₑ₁), and the difference between the second time period and the first time period is less than a second threshold (Tₗᵢₙₑ₄−Tₗᵢₙₑ₁<ε₂). When the plans do not participate in the carpool, the total time required is:

2*Tₗᵢₙₑ₁(T_{S2}−T_{S1})+Tₗᵢₙₑ₂+Tₗᵢₙₑ₄ (a)

When the plans participate in the carpool, the spend time required is:

Tₗᵢₙₑ₁+Tₗᵢₙₑ₃Tₗᵢₙₑ₂+Tₗᵢₙₑ₄ (b)

By subtracting formula (a) with formula (b), the saved time is:

2*Tₗᵢₙₑ₁(T_{S2}−T_{S1})+Tₗᵢₙₑ₂+Tₗᵢₙₑ₄)−(Tₗᵢₙₑ₁+Tₗᵢₙₑ₃+Tₗᵢₙₑ₂+Tₗᵢₙₑ₄)=Tₗᵢₙₑ₁+(T_{S2}−T_{S1})−Tₗᵢₙₑ₃ (c)

Since Tₗᵢₙₑ₃<ε₁ and T_{S2}>T_{S1}, the total saving time of the relay type in the transportation plan can be express as (Tₗᵢₙₑ₁+T_{S2}−T_{S1}) (d)

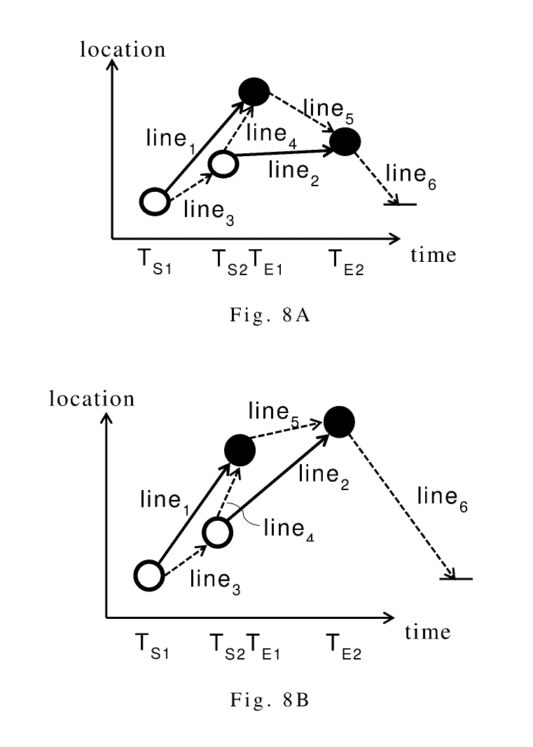

FIG. 8A and FIG. 8B show the carry type according to an embodiment of the disclosure. As shown, in carry type, the start-time of the second plan happens between the start-time of first plan and the end-time of the first plan (T_{E1}>T_{S2}>T_{S1}), the end-time of the second plan happens later than the end-time of the first plan (T_{E2}>T_{E1}). A third time period (Tₗᵢₙₑ₁) is the time taken from the start-location of the first plan to the destination-location of the first plan, the third time period is:

Tₗᵢₙₑ₁ (e)

A fourth time period is the time taken by the path starts from the start-location of the first plan through the start-location of the second plan to the destination-location of the first plan, the fourth time period is:

Tₗᵢₙₑ₃+Tₗᵢₙₑ₄ (f)

The fourth time period is not more than the third time period too much, by subtracting formula (f) with formula (e), the difference between the fourth time period and the third time period is less than a third threshold:

Tₗᵢₙₑ₃+Tₗᵢₙₑ₄−Tₗᵢₙₑ₁<ε₃ (g)

The time interval between the end-time of the first plan and the end-time of the second plan is less than a fourth threshold (ε₄), wherein the default value of the third threshold and the fourth threshold can be 5 minutes. The carry type can be further divided into backward type and forward type. FIG. 8A shows an example of backward type, wherein a fifth time period (Tₗᵢₙₑ₆) is the time taken from the destination-location of the second plan return to the start-location of the first plan, the fifth time period is less than the third time period (Tₗᵢₙₑ₆<Tₗᵢₙₑ₁). FIG. 8B shows an example of the forward type, wherein the fifth time period exceeds the third time period (Tₗᵢₙₑ₆>Tₗᵢₙₑ₁), and the difference between the fifth time period and the third time period is less than a fifth threshold (Tₗᵢₙₑ₆−Tₗᵢₙₑ₁<ε₅). When the plans do not participate in the carpool, the total time required is:

2*Tₗᵢₙₑ₁+Tₗᵢₙₑ₃+Tₗᵢₙₑ₂+Tₗᵢₙₑ₆ (h)

When the plans participate in the carpool, the spend time required is:

Tₗᵢₙₑ₃+Tₗᵢₙₑ₄+Tₗᵢₙₑ₅+Tₗᵢₙₑ₆ (i)

By subtracting formula (h) with formula (i), the saved time is:

(2*Tₗᵢₙₑ₁+Tₗᵢₙₑ₃+Tₗᵢₙₑ₂+Tₗᵢₙₑ₆)−(Tₗᵢₙₑ₃+Tₗᵢₙₑ₄+Tₗᵢₙₑ₅+Tₗᵢₙₑ₆)=2*Tₗᵢₙₑ₁−((Tₗᵢₙₑ₄+Tₗᵢₙₑ₅)−Tₗᵢₙₑ₂) (j)

Since Tₗᵢₙₑ₅<ε₄ and Tₗᵢₙₑ₄≈Tₗᵢₙₑ₂, the total saving time of the carry type in the transportation plan can be express as 2*Tₗᵢₙₑ₁.

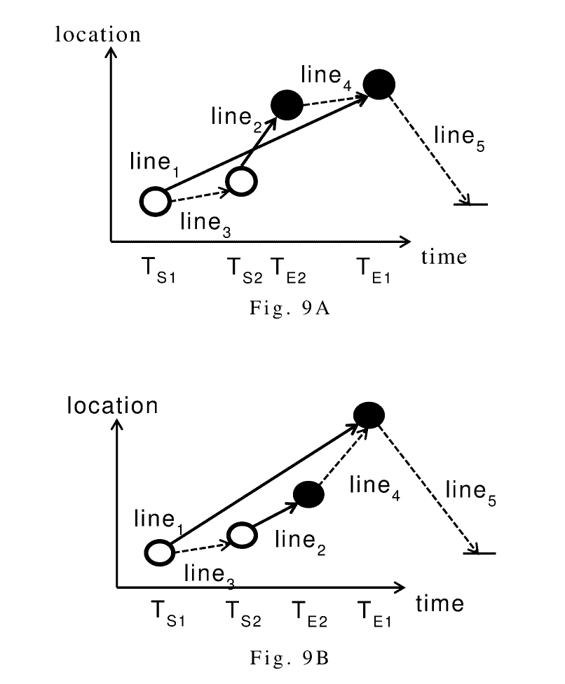

FIG. 9A and FIG. 9B show the cover type according to an embodiment of the disclosure. As shown, in cover type, the start-time of the second plan and the end-time of the second plan happens between the start-time of the first plan and the end-time of the first plan (T_{E1}>T_{E2}>T_{S2}>T_{S1}). A sixth time period (Tₗᵢₙₑ₁) is the time taken from the start-location of the first plan to the destination-location of the first plan, a seventh time period (Tₗᵢₙₑ₃+Tₗᵢₙₑ₂+Tₗᵢₙₑ₄) is the time taken from the start-location of the first plan through the start-location of the second plan and the destination-location of the second plan to the destination-location of the first plan, the seventh time period is:

Tₗᵢₙₑ₃+Tₗᵢₙₑ₂+Tₗᵢₙₑ₄ (k)

The seventh time period is not more than the sixth time period too much, by subtracting formula (k) with formula (f), the difference between the sixth time period and the seventh time period is less than a sixth threshold:

Tₗᵢₙₑ₃+Tₗᵢₙₑ₂+Tₗᵢₙₑ₄−Tₗᵢₙₑ₁<ε₆ (l)

wherein the default value of the sixth threshold can be 5 minutes. When the plans do not participate in the carpool, the total time required is:

2*Tₗᵢₙₑ₁+2*(Tₗᵢₙₑ₃+Tₗᵢₙₑ₂) (m)

When the plans participate in the carpool, the spend time required is:

Tₗᵢₙₑ₃+Tₗᵢₙₑ₂+Tₗᵢₙₑ₄+Tₗᵢₙₑ₅ (n)

By subtracting formula (m) with formula (n), the saved time is:

2*Tₗᵢₙₑ₁+2*(Tₗᵢₙₑ₃+Tₗᵢₙₑ₂)−(Tₗᵢₙₑ₃+Tₗᵢₙₑ₂+Tₗᵢₙₑ₄+Tₗᵢₙₑ₅)=Tₗᵢₙₑ₁+Tₗᵢₙₑ₃+Tₗᵢₙₑ₂−Tₗᵢₙₑ₄ (o)

Since Tₗᵢₙₑ₁≈Tₗᵢₙₑ₃+Tₗᵢₙₑ₂+Tₗᵢₙₑ₄, the total saving time of the cover type in the transportation plan can be express as:

2*(Tₗᵢₙₑ₃+Tₗᵢₙₑ₂) (P)

The methods and the transport systems integrate transport demands for matchmaking the demanders and the drivers. The demanders may use less shipment for shipping and the drivers may work more efficiently according to the carpool plan. The transport system makes the optimize transport path and creates the maximum benefit according to time and space parameters. The systems and methods of the transportation are not limited to items, the plants, the animals, and the human beings can be transported through the present system and method.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A transport system, comprising:
a first transport-requirement device and a second transport-requirement device, respectively providing first plan information and second plan information, wherein the first plan information comprises a start-location of a first plan, a destination-location of the first plan and a start-time of the first plan, and the second plan information comprises a start-location of a second plan, a destination-location of the second plan and a start-time of the second plan;
a transport-execution device, providing driver's information and driver confirmation; and a data processing server, providing carpool plans to the transport-execution device according to the driver's information, wherein the data processing server obtains the end-time of the first plan according to the first plan information, obtains the end-time of the second plan according to the second plan information, and generates the carpool plans according to a relationship among the first plan information, the end-time of the first plan, the second plan information and the end-time of the second plan.

2. The transport system as claimed in claim 1, wherein the carpool plan comprises a relay type, a carry type and a cover type, wherein:
in the relay type, the start-time of the second plan happens later than the end-time of the first plan, a time interval between the end-time of the first plan and the start-time of the second plan is less than a first threshold;
in the carry type, the start-time of the second plan happens between the start-time of the first plan and the end-time of the first plan, the end-time of the second plan happens later than the end-time of the first plan, a first time period is the time taken from the start-location of the first plan to the destination-location of the first plan, a second time period is the time taken by the path starts from the start-location of the first plan through the start-location of the second plan to the destination-location of the first plan, the second time period is not more than the first time period too much, the difference between the second time period and the first time period is less than a second threshold, the time interval between the end-time of the first plan and the end-time of the second plan is less than a third threshold; or
in the cover type, the start-time of the second plan and the end-time of the second plan happens between the start-time of the first plan and the end-time of the first plan, a third time period is the time taken from the start-location of the first plan to the destination-location of the first plan, a fourth time period is the time taken from the start-location of the first plan through the start-location of the second plan and the destination-location of the second plan to the destination-location of the first plan, the fourth time period is not more than the third time period too much, the difference between the fourth time period and the third time period is less than a fourth threshold.

3. The transport system as claimed in claim 1, further comprising a plurality of third transport-requirement devices providing third plan information, wherein:
the third plan information comprises a start-location of third plan, a destination-location of the third plan and a start-time of the third plan;
the data processing server obtains the end-time of the third plan according to the third plan information, and generates the carpool plans according to the relationship among the third plan information, the end-time of the third plan, the first plan information, the end-time of the first plan, the second plan information and the end-time of the second plan.

4. The transport system as claimed in claim 1, wherein the transport-execution device comprises:
a geographic-information upload module, providing information as to location of delivery driver to the data processing server; and
a transport plan-delivery module, receiving the carpool plans from the data processing server and transmitting the driver confirmation to the data processing server.

5. A transport method, comprising:
receiving the first plan information and the second plan information respectively from the first transport-requirement device and the second transport-requirement device, wherein the first plan information comprises the start-location of the first plan, the destination-location of the first plan, the start-time of the first plan and carpool information of the first plan, and the second plan information comprises the start-location of the second plan, the destination-location of the second plan, the start-time of the second plan and carpool information of the second plan; and
providing the carpool plans to the transport-execution device according to the driver's information, wherein the end-time of the first plan is obtained according to the first plan information, the end-time of the second plan is obtained according to the second plan information, and the carpool plans are generated according to the relationship among the first plan information, the end-time of the first plan, the second plan information and the end-time of the second plan.

6. The transport method as claimed in claim 5, further comprising providing a tracking service with showing the delivery status according to the driver's information.

7. The transport method as claimed in claim 5, wherein the carpool plan comprises a relay type, a carry type and a cover type, wherein:
in the relay type, the start-time of the second plan happens later than the end-time of the first plan, a time interval between the end-time of the first plan and the start-time of the second plan is less than a first threshold;
in the carry type the start-time of the second plan happens between the start-time of the first plan and the end-time of the first plan, the end-time of the second plan happens later than the end-time of the first plan, the first time period is the time taken from the start-location of the first plan to the destination-location of the first plan, the second time period is the time taken by the path starts from the start-location of the first plan through the start-location of the second plan to the destination-location of the first plan, the second time period is not exceeds the first time period too much, the difference between the second time period and the first time period is less than a second threshold, the time interval between the end-time of the first plan and the end-time of the second plan is less than a third threshold; or
in the cover type the start-time of the second plan and the end-time of the second plan happens between the start-time of the first plan and the end-time of the first plan, the third time period is the time taken from the start-location of the first plan to the destination-location of the first plan, the fourth time period is the time taken from the start-location of the first plan through the start-location of the second plan and the destination-location of the second plan to the destination-location of the first plan, the fourth time period is not exceed the third time period too much, the difference between the fourth time period and the third time period is less than a fourth threshold.

8. The transport method as claimed in claim 5, further comprising:
providing the third plan information from a plurality of third transport-requirement devices, wherein the third plan information comprises the start-location of third plan, the destination-location of the third plan and the start-time of the third plan; and
obtaining the end-time of the third plan according to the third plan information, and generating the carpool plans according to the relationship among the third plan information, the end-time of the third plan, the first plan information, the end-time of the first plan, the second plan information and the end-time of the second plan.

9. The transport method as claimed in claim 5, wherein when the carpool information of the first plan and the carpool information of the second plan participate in the carpool plan, the method further comprises:
broadcasting the request for looking the driver who accepts the carpool plans; or
assigning the carpool plans to the transport-execution device by the data processing server according to the driver's information which received from the transport-execution device.

10. The transport method as claimed in claim 5, wherein when the carpool information of the first plan or the carpool information of the second plan does not participate in the carpool plan, the method further comprises:
broadcasting the request for looking the driver who accepts a single plan; or
assigning the carpool plans to the transport-execution device by the data processing server according to the driver's information which received from the transport-execution device.

11. The transport method as claimed in claim 5, further comprising:
setting the driver's information on the transport-execution device;
checking whether the driver participates in the carpool plan; and
ignoring the carpool plan messages which are broadcasted from the data processing server when the driver does not participate in the carpool plan.
